(19) United States
(12) Patent Application Publication
(10) Pub. No.: US 2008/0100140 A1
(43) Pub. Date: May 1, 2008

(54) REMOTE POWER MANAGEMENT AND MONITORING SYSTEM FOR SOLID STATE CIRCUIT BREAKER CONTROL WITH MANUAL BYPASS

(75) Inventors: Richard W. Sorenson, Stuart, FL (US); Simon Cordner, Voorhees, NJ (US); Ronald Mansley, Kintnersville, PA (US); Keith Belke, Perkasie, PA (US)

Correspondence Address: CANTOR COLBURN, LLP, 20 Church Street, 22nd Floor, Hartford, CT, 06103, US

(73) Assignee: Carling Technologies, Inc., Plainville, CT (US)

(21) Appl. No.: 11/933,681

(22) Filed: Nov. 1, 2007

Related U.S. Application Data
(60) Provisional application No. 60/855,888, filed on Nov. 1, 2006.

(51) Int. Cl. H02J 1/00; H02J 4/00

(52) U.S. Cl. 307/40

(57) ABSTRACT

A power management and monitoring system for controlling an electrical device powered by a power supply is disclosed. The system may include a circuit breaker enclosure box structured to monitor and manage power to the electrical device via a centralized data bus and centralized power bus. The circuit breaker enclosure box may include at least a remotely actuated solid state electronic circuit breaker (ECB) that monitors and manages power to the electrical device and a switch connected to the ECB and capable or remotely bypassing the ECB. The system may also include a display and controller that can remotely monitor and control the electrical device by remotely actuating the ECB.

### CROSS REFERENCE TO RELATED APPLICATION

This application claims priority to U.S. provisional application 60/855,888 filed Nov. 1, 2006, the entire contents of which are incorporated herein by reference.

### FIELD OF INVENTION

This invention is related to the power systems management art and is also related to the circuit breaker art.

### BACKGROUND

Electrical systems for power management of AC and/or DC powered systems are growing increasingly complex. A good example of the difficulties posed by modern systems is the growth in utilization of DC systems installed in many marine vessels. However, as the number of DC devices on even a small recreational vessel has greatly increased, the overall wiring concepts have not changed significantly. Therefore, a typical marine vessel has one centralized power control panel located near the navigation station that contains many manually operated circuit breakers. This results in a large number of cables running from the back of the power control panel. However, most of these cables run in parallel to other cables routed throughout the vessel. Therefore, it has been proposed that a centralized power bus run down the center of the vessel for example, that may be tapped by devices as needed or as installed, would reduce and simplify the overall wiring requirements significantly.

This centralized power bus could also be controlled and monitored remotely by a power management system and monitoring system having a display such as a touch screen display. Touch screen displays can be located wherever they are needed such as in an engine room or even outdoors by an outdoor helm station. For each piece of equipment, a switch could be located between the bus and the device. This would replace a circuit breaker previously located on a centralized power panel. However, because these remotely located circuit breakers would be physically located throughout the vessel, manual operation of the circuit breakers is not practical. Therefore, remotely actuated circuit breakers that are integrated into a centralized power management system are desirable.

Environmental operating conditions also typically pose challenges to remotely actuated systems. For example, the United States military specifies that many circuit breakers conform to MILC 55-629 standards for resistance to humidity, salt spray, shock, and other factors for these reasons. The MILC 55-629 standards are also incorporated by reference into this specification.

Additionally, different manufacturers use different data protocols for sending the large amounts of modern data used in common place devices such as navigational chart plotters which may be integrated with radar units, weather instruments, internet interfaces, and GPS units to show a vessel's position and the positions of other vessels and the environment on one real time display screen for example. Therefore, because the amount of commonplace data available for use has exploded, the increased number of data wires has also become a wiring problem.

Therefore, a “three cable boat” concept has been advocated by many marine professionals. In this system, two centralized power cables and a data cable are located on a centralized bus. Standardized data protocols such a NMEA 2000 have been developed so that data systems can communicate and connect in a “plug and play” fashion. The NMEA 2000 standards are hereby incorporated by reference into the present application.

Traditionally, circuit breakers are typically mounted in standardized shaped and sized panels of circuit breaker boxes. Because circuit breakers are normally mounted next to each other for ease of use, “real estate” or physical space on the breaker box is at a premium. Therefore, improved designs for circuit breaker boxes are needed. The present, assignee, Carling Technologies has also filed a U.S. provisional application, 60/727,360, REMOTE POWER MANAGEMENT AND MONITORING SYSTEM WITH REMOTE CIRCUIT BREAKER CONTROL filed Oct. 17, 2005, the entire contents of which are incorporated herein by reference and a corresponding U.S. utility application Ser. No. 11/581,672 on Oct. 16, 2006 of the same title, the entire disclosure of which is also incorporated herein by reference.

Thus, in vessel, auto, aerospace, aviation, transportation, and home and buildings applications among others, reducing the overall amount of wiring in the overall system, and the overall complexity of wiring designs is important for reducing production and installation costs, improving reliability, and for increasing the ease of maintenance and troubleshooting. Advanced power management also allows for “smart systems” and programmable systems that can actively react to changes in loads and “load shedding” situations which vessels often experience.

U.S. Pat. Nos. 4,272,687 and 5,752,047 and United States Patent Publications 2002/0108065 and 2003/0095367 illustrate some examples of conventional power management systems. However, there are still many improvements that can be made in the field. For example, due to many different manufactures, old wiring concepts, and a general lack of an overall integrated and planned power management vision, substantial difficulties exist for those skilled in the art to produce suitable modern remote power management systems and remotely actuated circuit breakers. Thus, devices, methods, and systems that may solve some or all of these problems are needed for many applications, including, for example, the marine industry.

### SUMMARY OF THE INVENTION

Thus, an embodiment may comprise a power management control and monitoring system and remotely actuated circuit breaker actuator apparatus.

An embodiment of a power management and monitoring system may include a circuit breaker enclosure box structured to monitor and manage power to the electrical device via a centralized data bus and centralized power bus. The circuit breaker enclosure box may include at least a remotely actuated solid state electronic circuit breaker (ECB) that monitors and manages power to the electrical device and a switch connected to the ECB and capable or remotely bypassing the ECB. The system may also include a display and controller that can remotely monitor and control the electrical device by remotely actuating the ECB.

An embodiment may also comprise a power management and monitoring system for a marine vessel comprising: at least one or more centralized data and power buses for connecting and controlling DC electrical devices and DC power supplies on the marine vessel; at least one or more display and controller for controlling and monitoring the DC electrical devices and the power supplies on the vessel via the centralized data and power buses; and remotely located and remotely actuated DC circuit breaker enclosure box, which is remotely located from the at least one display and controller, and which comprise at least one or more remotely actuated DC circuit breakers located therein, wherein the remotely actuated DC circuit breakers are actuated via the centralized data and power buses by the at least one display and controller.

An embodiment may also comprise a method for simplifying the construction and installation of power management and monitoring systems for a marine vessel, transportation vehicle, or building comprising: providing at least one or more centralized data and power buses for connecting and controlling electrical devices and power supplies on the marine vessel, transportation vehicle, or building; providing at least one or more display and controller for controlling and monitoring the DC electrical devices and the DC power supplies on the vessel or building via the centralized data and power buses; and providing at least one or more remotely located and remotely actuated DC circuit breaker enclosure boxes, which are remotely located from the at least one display and controller, and which comprise at least one or more remotely actuated DC circuit breakers located therein wherein the remotely actuated DC circuit breakers are actuated via the centralized data and power buses by the at least one display and controller.

An embodiment may also comprise a computer program product for power management and monitoring electrical controlled systems for a marine vessel device in a computer environment, the computer program product comprising a storage medium readable by a processing circuit and storing instructions for execution by the processing circuit for facilitating a method comprising: providing data communications via at least one or more centralized data and power buses for connecting and controlling electrical devices and power supplies on the marine vessel, transportation vehicle, or building; controlling and monitoring the DC electrical devices and the DC power supplies on the vessel or building via at least one or more display and controller via the centralized data and power bus; controlling the DC power supplies via remotely actuated DC circuit breakers which are actuated via the centralized data bus and power bus by the at least one display and controller; and providing at least one or more remotely located and remotely actuated DC circuit breaker enclosure boxes, which are remotely located from the at least one display and controller, and which contain the at least one or more remotely actuated DC circuit breakers.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1A is an exploded perspective view of a circuit breaker enclosure box according to at least an embodiment of the present invention.

FIG. 1B is a side view of a three-position switch in the mechanical bypass “ON” position according to at least an embodiment of the present invention.

FIG. 1C is a side view of a three-position switch in the “Off” position according to at least an embodiment of the present invention.

FIG. 1D is a side view of a three-position switch in the “Solid state control ON” position according to at least an embodiment of the present invention.

FIG. 1E is a schematic view of a marine vessel with a power management system according to at least an embodiment of the present invention.

FIG. 2 is a top view of the switches and circuit boards of a circuit breaker enclosure box according to at least an embodiment of the present invention.

FIG. 3 is an enlarged top view of the switches and circuit boards of a circuit breaker enclosure box according to at least an embodiment of the present invention.

FIG. 4 is an enlarged top view of the switches of a circuit breaker enclosure box according to at least an embodiment of the present invention with a heat sink in place.

FIG. 5 is a top view of a circuit breaker enclosure box according to at least an embodiment of the present invention with a heat sink in place.

FIG. 6 is a top view of a circuit breaker enclosure box according to at least an embodiment of the present invention with a heat sink and flexible plastic switch cover in place.

FIG. 7 is screen shot of a control screen of a display a circuit breaker enclosure box according to at least an embodiment of the present invention.

FIG. 8 is a schematic circuit diagram of at least an embodiment of the present invention.

FIG. 8A is a schematic circuit diagram of the basic solid state circuit without the manual bypass.

FIG. 9 is a schematic circuit diagram of the basic solid state circuit with an additional reversing circuit.

FIG. 10 is a schematic circuit diagram of the basic solid state circuit with an additional reversing circuit.

FIG. 11 is a graph showing solid state dimming via pulse width modulation according to at least an embodiment of the present invention.

FIG. 12 is a graph showing solid state dimming according to at least an embodiment of the present invention.

FIG. 13 is a plan view of a circuit breaker enclosure box according to at least an embodiment of the present invention.

FIG. 14 is a side view of a circuit breaker enclosure box according to at least an embodiment of the present invention.

FIG. 15 is a plan view of a circuit breaker enclosure box according to at least an embodiment of the present invention.

FIG. 16 is a side view of a circuit breaker enclosure box according to at least an embodiment of the present invention.

FIG. 17 is a plan view of a circuit breaker enclosure box according to at least an embodiment of the present invention.

FIG. 18 is a side view of a circuit breaker enclosure box according to at least an embodiment of the present invention.

FIG. 19 is a plan view of a switch interface module according to at least an embodiment of the present invention.

FIGS. 20(a) and 20(b) are view of a 4-button control module according to at least an embodiment of the present invention.

FIGS. 21(a) and 21(b) are views of an 8-button control module according to at least an embodiment of the present invention.

FIG. 22 is a perspective view of a 6-button control module according to at least an embodiment of the present invention.

FIG. 23 is a view of a 13-button control module according to at least an embodiment of the present invention.

### DETAILED DESCRIPTION OF THE PREFERRED EMBODIMENTS

At least an embodiment of this system is identified in the art by the Morplex trademark to Carling Technologies.

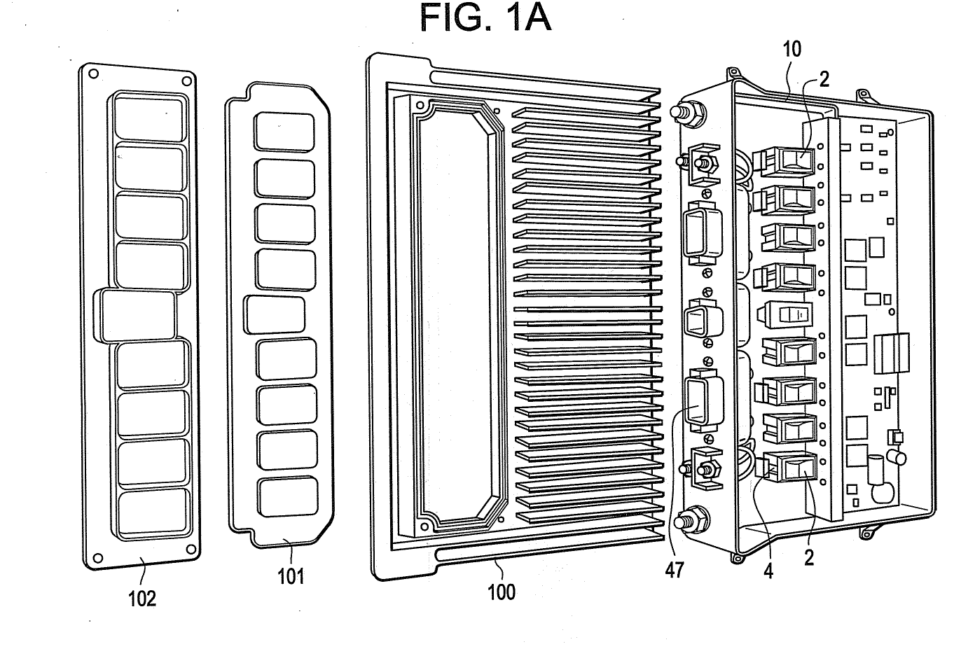

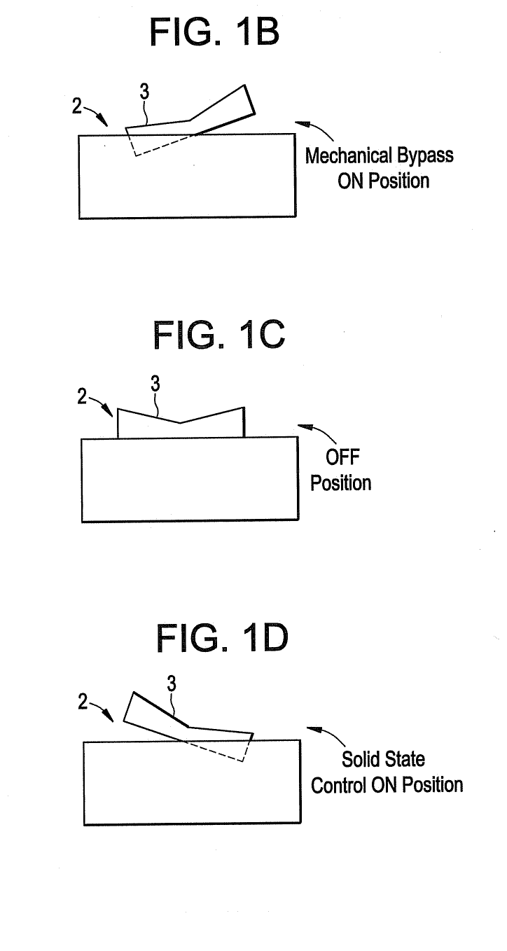

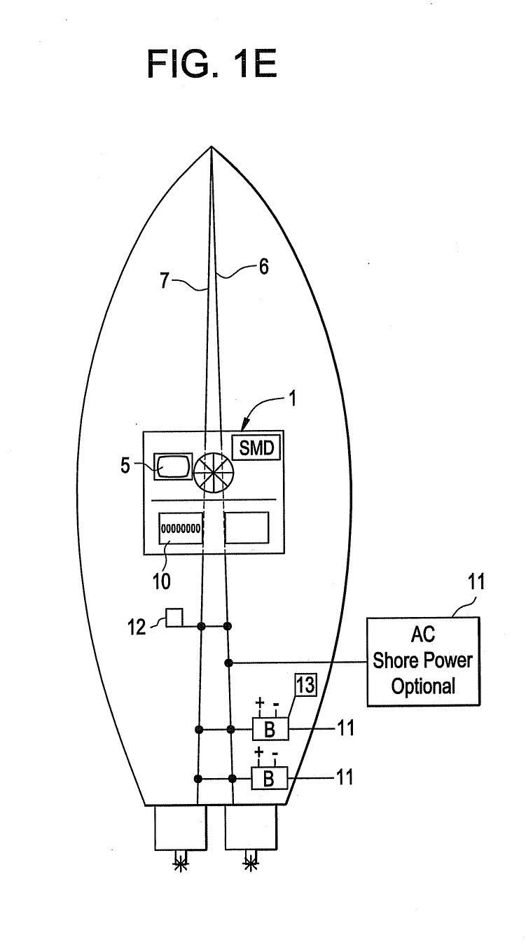

As best seen in the exemplary embodiment shown in FIGS. 1A, 6 and 7, the solid state remote power management and monitoring system (SSPMMS) 1 which may be interfaced to a PC computer or touch screen display 5 on board a vessel for example (see FIG. 1E), and which also uses the remotely actuated circuit breaker system enclosed in circuit breaker enclosure box 10, affords heretofore unavailable advantages in remotely managing power and monitoring vessel functions. It does so with extreme reliability and safety by, among other things, implementing a manual bypass control three-position switch 2 as shown in FIG. 1B and by enabling software control of power management for the vessel whereas only physical fixed characteristic switches were typically provided in the past.

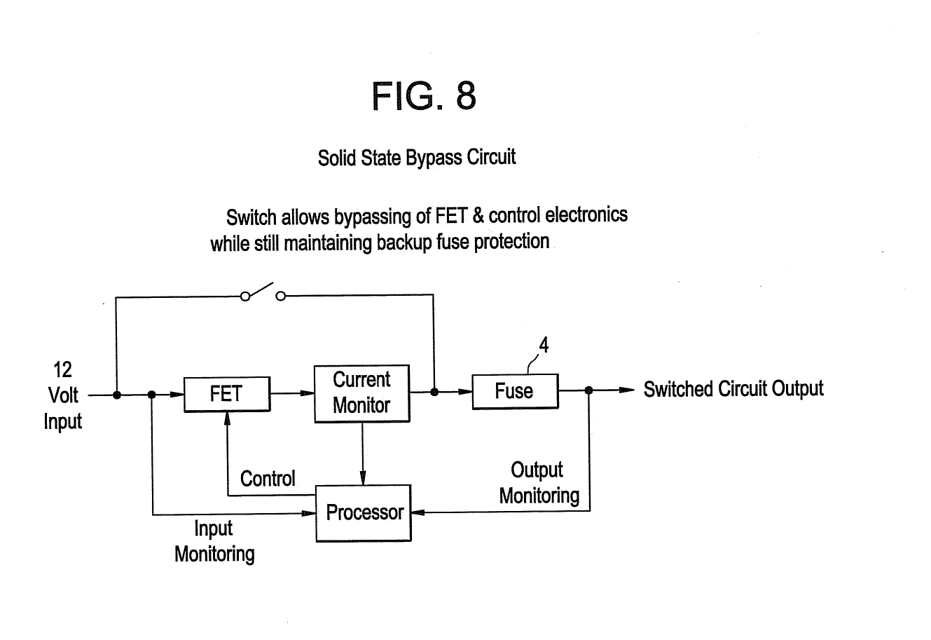

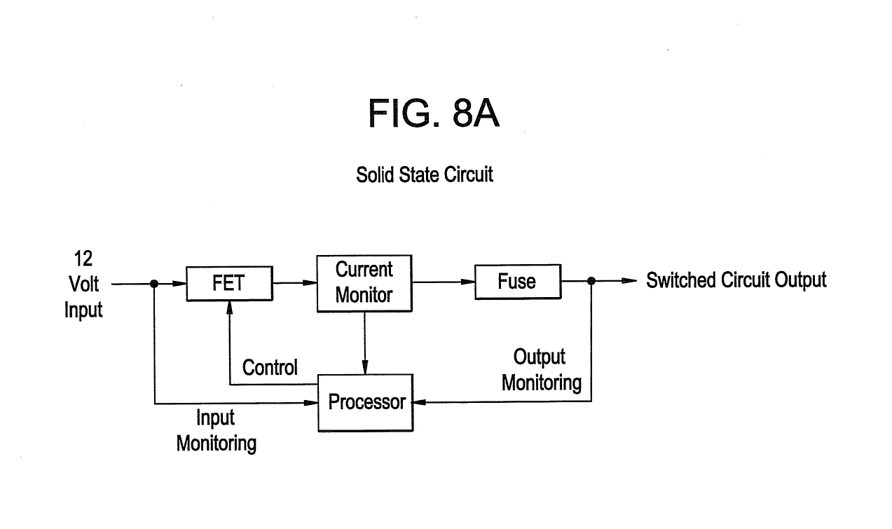

As a fail-safe feature, if a solid state device fails and the switch 2 is stuck in a “shorted on” position, the switch 2 can be manually operated to bypass the solid state controls by moving the switch lever 3 to the “Off” position as shown in FIG. 1C or to bypass “On” position shown in FIG. 1B. An easily replaceable fuse 4 is also included in the circuit as shown in FIG. 8 as another fail-safe feature. Thus, by implementing the unique three-position switch 2 (see FIGS. 1B-1D), which is a combination of mechanical and solid state devices, a novel control apparatus is created by the present invention.

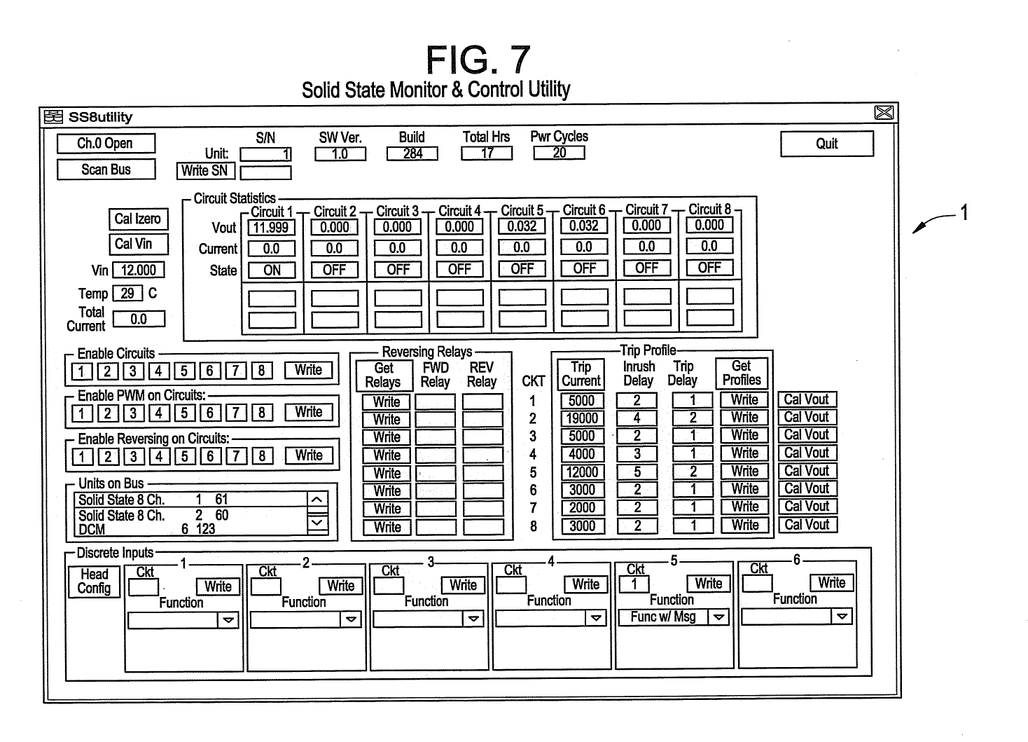

When coupled with an electronic power monitoring system as shown in FIGS. 7 and 8 and/or an optional data bus (6,7) such as a NMEA 2000 or CAN bus, a novel solid state remote power management and monitoring system (SSPMMS) 1 is created which may be used through touch screen display 5 or interfaced with a personal computer (PC) not shown. This system is especially useful and cost effective for smaller pleasure vessels (see FIG. 1E) such as small and medium sized power boats.

As shown in FIG. 1E, The SSPMMS 1 basic components may comprise, but are not limited to: touch screen control panels 5, data buses (6, 7); DC power distribution boxes 10 typically having DC remotely actuated circuit breakers, power supplies 11, data acquisition units 12 such as battery monitor unit 13. The devices are arranged on a centralized bus system which in this case comprises a primary NMEA 2000 data bus 6 and a secondary NMEA 2000 data bus 7 and centralized power bus (not shown).

The SSPMMS 1 is comprehensive, flexible, and easily expandable. The SSPMMS 1 not only provides the operator complete visibility and control of a vessel's electrical system from any control screen 5, but the SSPMMS 1 also, via the buses (6, 7), provides a user with remote monitoring of alarm functions, battery, engine and generator data, and even electronic instrumentation such as, but not limited to, depth sounders, GPS units, radar units, Internet interfaces and Internet data, chart plotting graphics, electronic compasses, and multiple additional electronics (not shown).

Subsequent to vessel installation for example, the SSPMMS 1 may be easily expanded with additional features and software upgrades. Thus, the SSPMMS 1 places the captain in control of desired systems in one centralized monitoring location for example, at the wheel (see FIG. 1E); it increases access and interactivity with the ship's vital systems, and, most importantly, it increases vessel safety.

With the SSPMMS 1 there is no more lack of awareness when a circuit breaker trips and a freezer unknowingly is shut down on the vessel for example. Audible alarms may be assigned to circuit breakers as desired. There is no more burn out of a compressor pump because of a brown-out low voltage situation, since the SSPMMS 1 system is a “smart system” and can be programmed to turn off designated circuit breakers in the event of a brown-out, and then turn them back on when voltage has recovered. There is no more frustration from tripping of the dockside circuit breakers due to overloading. Load shedding and automatic placement back online can be programmed into the system both for AC and DC should current usage reach higher than desired levels. The ability to reset a tripped DC on board circuit breaker is immediate given remotely actuated circuit breakers. Thus, the possibilities and benefits in power management and monitoring are virtually endless.

The SSPMMS 1 also enables substantial savings in ship's construction as a result of significant reductions in vessel wiring complexity. The builder is provided with the unique flexibility of being able to locate circuit breaker panels 10 remotely without normal access and environmental considerations, thereby saving space and enabling the use of the most direct and efficient wiring schemes such as a centralized bus or “3-wire” system for example. The results are lower wire harnessing costs, lower labor installation costs, and significant weight savings.

The SSPMMS 1 platform also provides protection from obsolescence as the capabilities of the system may be subsequently enhanced with future software updating and installation of new NMEA 2000 components for example as they become available.

Capabilities—The SSPMMS 1 remotely monitors and controls all DC power distribution and circuit protection, and monitors the ship's operating functions. The system may employ NMEA 2000 communications protocol and may provide but is not limited to:
1. Immediate remote visual and audible identification of DC circuit breaker tripping.
2. Remote activation of DC circuit breakers.
3. Remote switching of all DC connected components.
4. Accurate monitoring of current flow to every DC load.
5. Programmable dimming functions for DC lighting.
6. Immediate recognition of no-load situations for activated DC loads.
7. Remote monitoring of vessel shore and generator power.
8. Programmable automatic load shedding and re-activation at selectable current levels.
9. Programmable automatic low-voltage brownout protection for operator selected loads.
10. Monitoring of generator and engine operating parameters.
11. Monitoring of Battery voltages, current usage, temperatures, and state-of-charge.
12. Monitoring of fuel, alarm functions, and equipment activity, with complete bilge pump operations monitoring.
13. Access to NMEA 2000 compliant electronics connected to the communication bus.

In summary, the SSPMMS 1 comprises the following features and benefits: simplicity of operation with intuitive programming; efficient interfacing with ease of installation, safe and secure operation—the system enables operational security coding to protect selected circuits from inadvertent remote activation.

System Redundancy to virtually eliminate single point failures—the system may be installed with two separate NMEA 2000 bus lines (6,7) and may continually operate with two processors in the online devices driving both buses. In the event of the failure or severing of the primary bus line 6, the system automatically switches to the secondary bus 7 and provides notification of the primary bus 6 failure; likewise, should one of the primary bus processors fail in a system's online device, the system will automatically switch to the secondary bus 7 and provide notification of the failure. Also, while operating on the primary bus 6, the system constantly monitors the secondary bus and will provide notification of a secondary bus failure.

Fail Safe operation—in the extremely unlikely case of a complete shutdown of the electronic control system, there is no effect on the continuity of either the DC circuit protection systems. The DC circuit breaker panels (10) will automatically switch to one of two internal power supplies to maintain their dual internal processors controlling the electronic breaker trip settings. Should the two processors, or the two back-up internal power supplies within a DC panel fail, the DC circuits may be manually activated with non-electronic modules or switches via switch 3.

Installation flexibility for breaker panel locations—DC (10) breaker panels may be mounted in remote non air-conditioned locations-both the solid state DC circuit breakers 14 provide consistent protection within an extreme range of ambient temperature environments for example, but not limited to: (−40° C. to +85° C.). This is a significant improvement over thermo controlled circuit breakers which need to be calibrated for temperature and which are severely affected by temperature.

Total awareness and control of ship's power—Every online PMMS 1 LCD touch screen control panel 5 provides complete monitoring and control of the vessel DC circuit breakers, monitoring of all power source data—including voltage, frequency, and amperage for all generator 16 and shore-power 15 feeds, and monitoring of any connected ship's systems, including alarm functions, electronics, and engine and generator functionality.

Expandable functionality—The system accommodates the addition of NMEA 2000 compliant electronics and other protocols.

Programmability—The system enables direct programming of numerous functions by operator touch screen entry via displays 15, and also provides the capability of internal software updating.

Built-in Diagnostics—Multiple diagnostics are built into the system to facilitate management.

Certifications—The system is tested to the Radio Technical Commission for Aeronautics (RTCA) specification DO-160E in all essential categories. AC circuit breakers are tested to meet Mil Spec standards and will have UL listing with additional desired agency certifications, including CE, Lloyds, etc. The communication protocol is certified to NMEA 2000, and the system has passed specific in-vessel testing for both radar and high single-sideband RFI environments.

Control Panels

When using the PMMS 1, a minimum of two Touch Screen Control (TSCs) control panels 5 should be installed for redundancy. A custom logo or design, as desired by the customer, may be inserted on the main menu page. The control panels 5 are multi-function color LCD touch-screens, which, dependent upon the particular installation, will present multiple pages of information and control functions such as, but not limited to:
Alarm systems monitoring (fire, bilge, etc.)
Circuit Breaker switching and monitoring (AC and DC)
Programmable control of DC lighting with dimming functions
Remote switching of all DC loads
Recognition of DC load disconnect and monitoring of individual DC load amperage
Essential DC system monitoring—voltages, current levels
Essential AC system monitoring—voltages, current levels
Selection of circuits for low voltage brown-out protection
Load shedding status as programmed
Fuel monitoring
Water Monitoring
Pump monitoring
Battery bank monitoring
Engine parameter monitoring
Generator parameter monitoring
NMEA 2000 bus connected electronics access (GPS, Depth-sounder, compass, etc.)
   Data Bus

In the embodiment of FIG. 1, the data communication protocol linking the various elements of the PMMS 1 is a CAN bus as defined by NMEA 2000 specifications. However, other systems are possible. As the system provides monitoring and control of the vessel's AC and DC electrical systems, a maximum degree of safety, redundancy, and dependability is designed into the system. The system is installed with two separate bus feed lines, one primary 6 and one secondary 7, and also employs two separate NMEA2000 multiplexing drivers in the system's bus connected components. Thus, in the unlikely event that the primary bus line 6 becomes compromised, damaged or severed, or alternatively, a multiplexing circuit within an MCS device fails, the system will automatically switch to the alternate bus line and processors, and provide notification of the occurrence. Likewise, while the system is operating on the primary bus 6, the secondary bus 7 is always active and monitored. Thus, while not being employed for system control, should the secondary bus 7 fail, the system will recognize and indicate its failure. It is subsequently necessary that the problem be rectified to enable the system to return to its normal fail safe mode of operation. The system may be installed and operated with a single bus line.

DC Circuit Breaker Panels

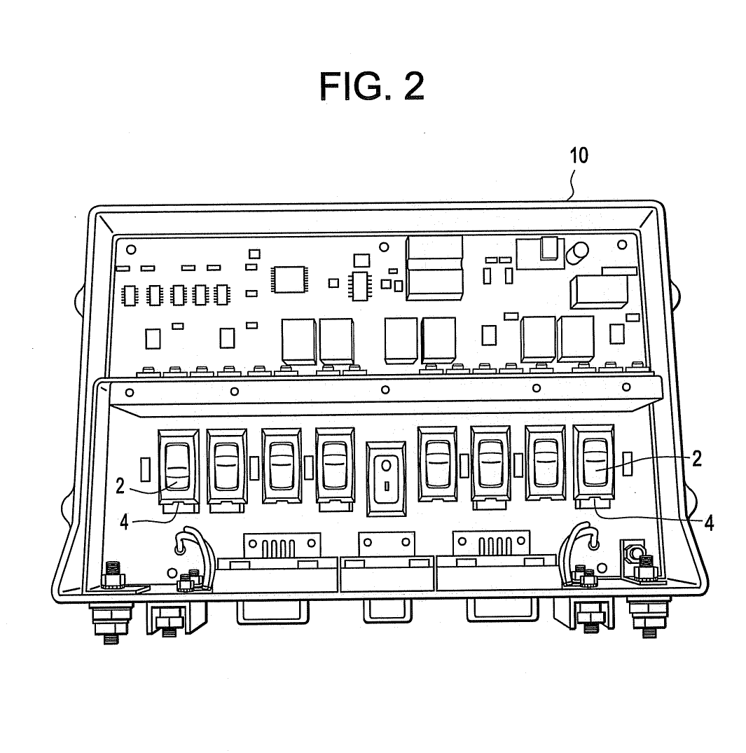

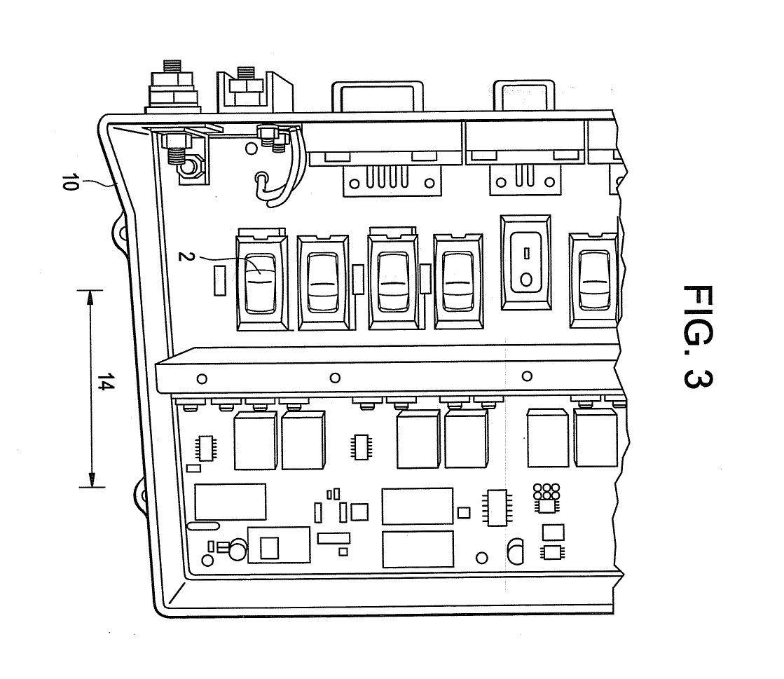

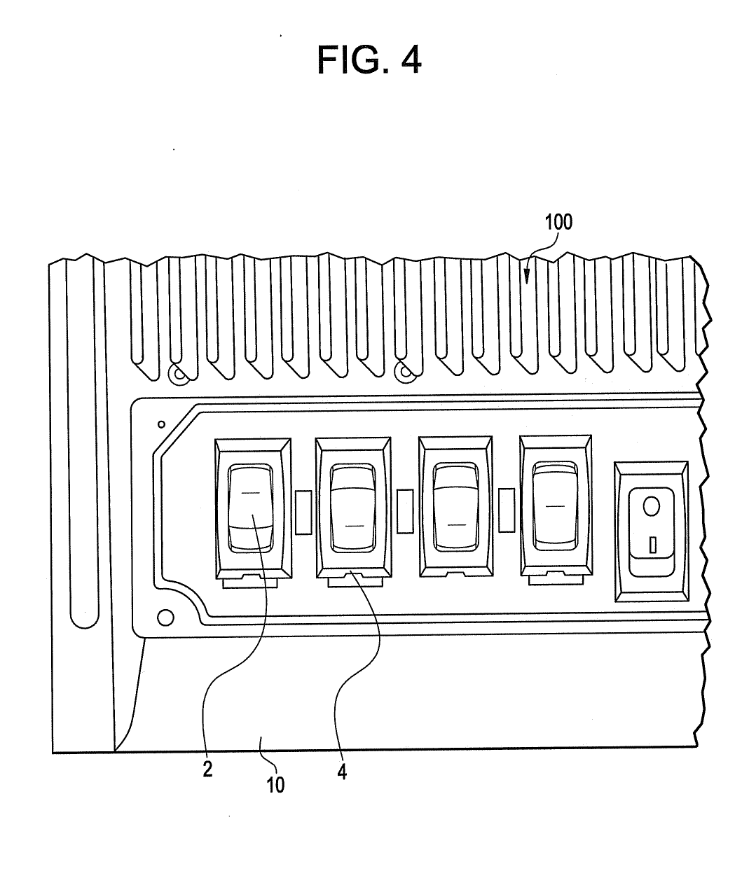

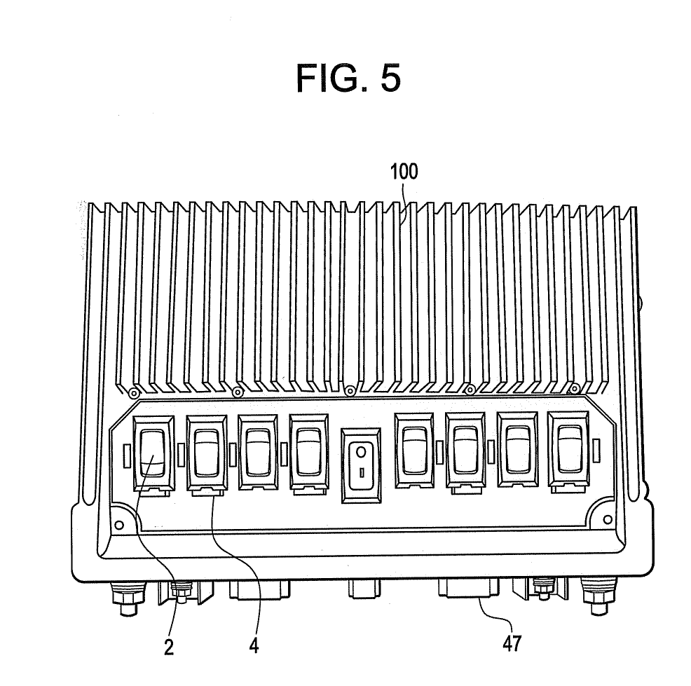

As shown in FIGS. 1A through 5, for DC circuit protection and distribution, the SSPMMS 1 system may employ one or more DC Panels (DCP) in enclosure box 10, each of which will house for example eight single pole solid-state Electronic Circuit Breakers (ECB) 14 comprised on switches 2 and associated electronics. Any individual DC Panel can protect, distribute and control either 12 volt or 24 volt power, as dictated by the power supplied to that individual DCP. The DCPs 10 and ECBs 14 within may be subject to large temperature variations without degradation of performance, allowing them to be mounted remotely in non air-conditioned locations. In an embodiment, for example, each electronic circuit breaker 14 has a current capacity of 30 amperes DC, and will assume its desired current protection rating by insertion into its specific location within a DC panel. Each location's current protection rating is programmed into the Multiplexed Control System during installation, and may subsequently be modified when necessary. Thus maintenance of onboard spares is greatly simplified, as all standard Electronic Circuit Breakers 14 are identical.

DC Electronic Circuit Breakers

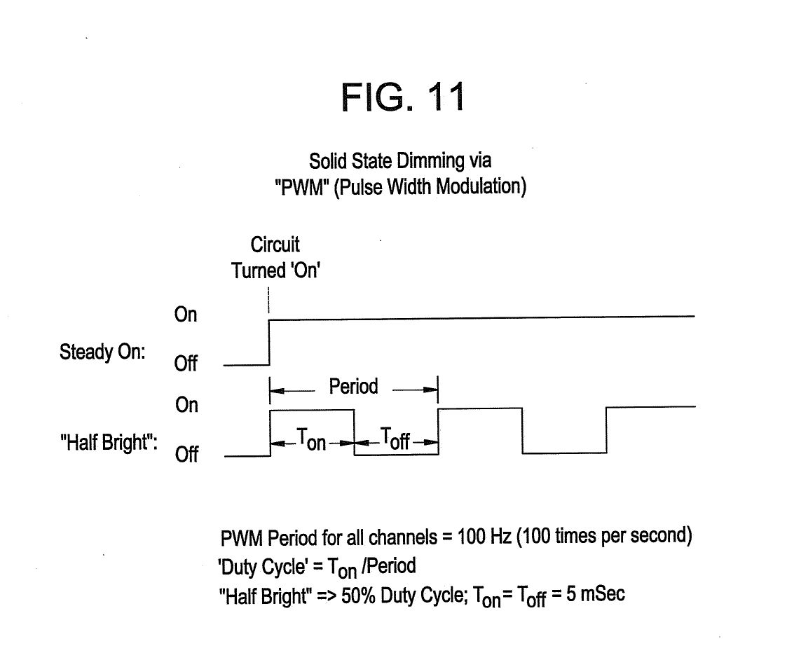

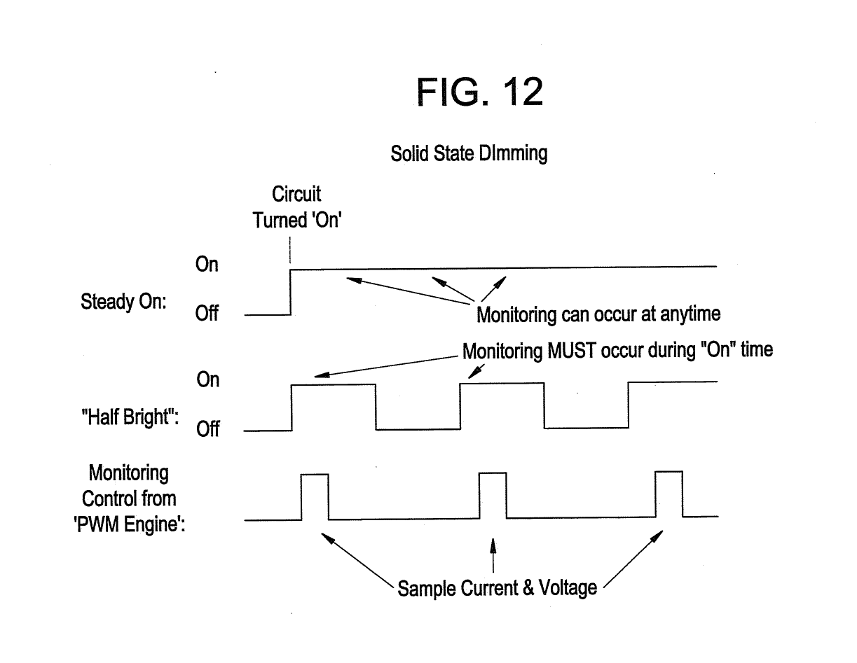

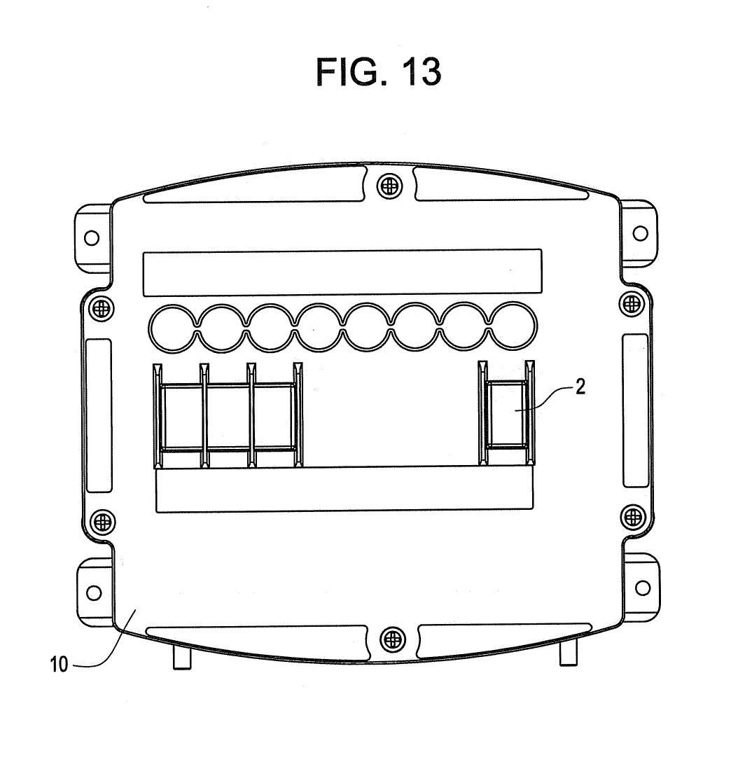

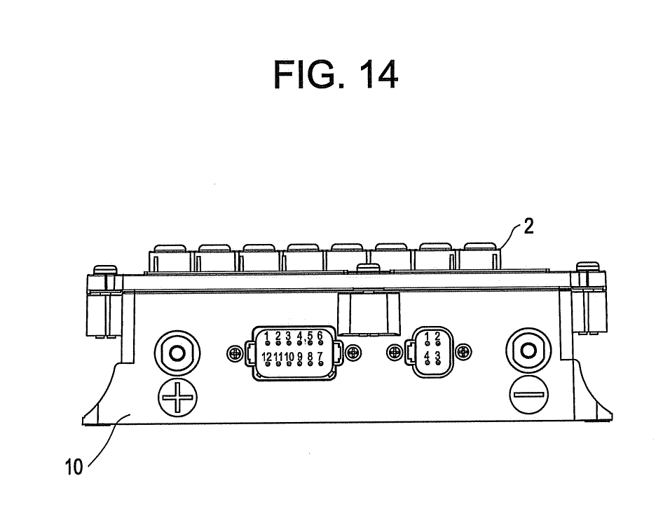

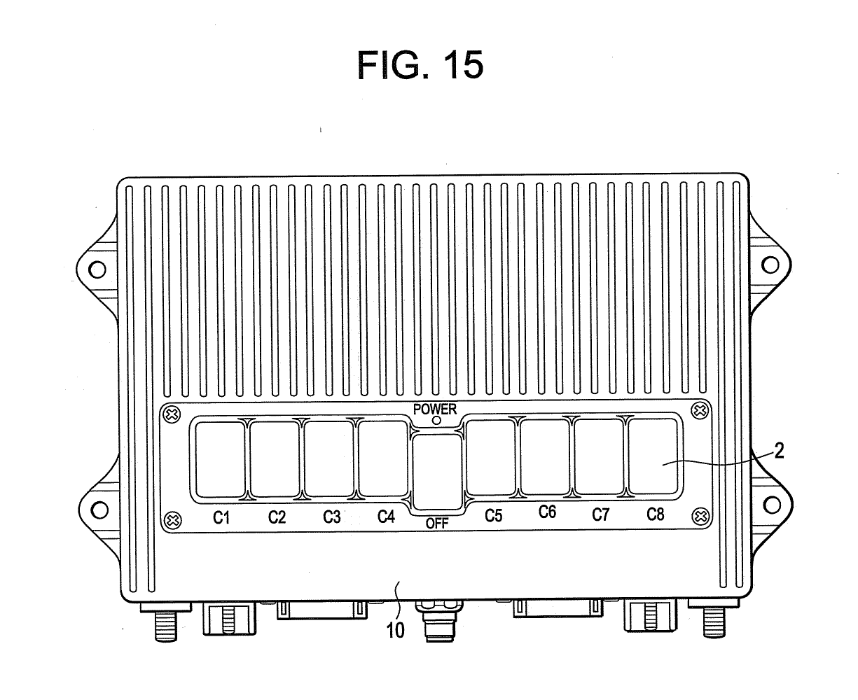

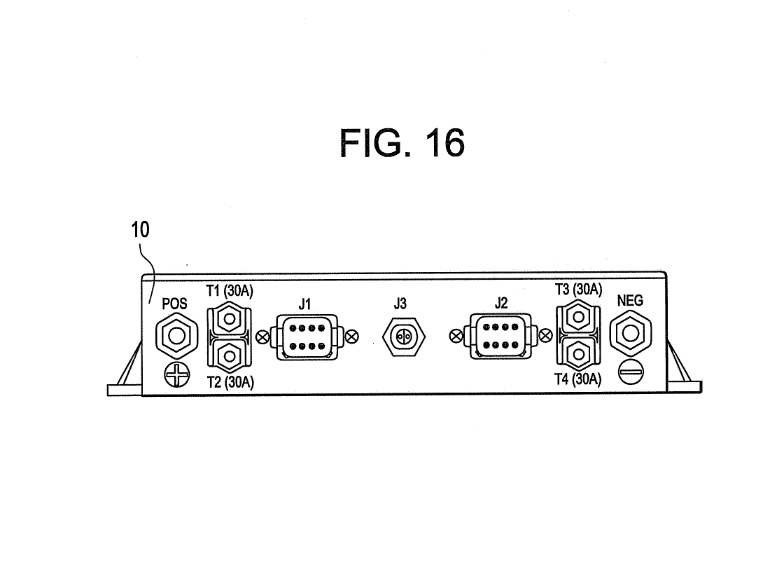

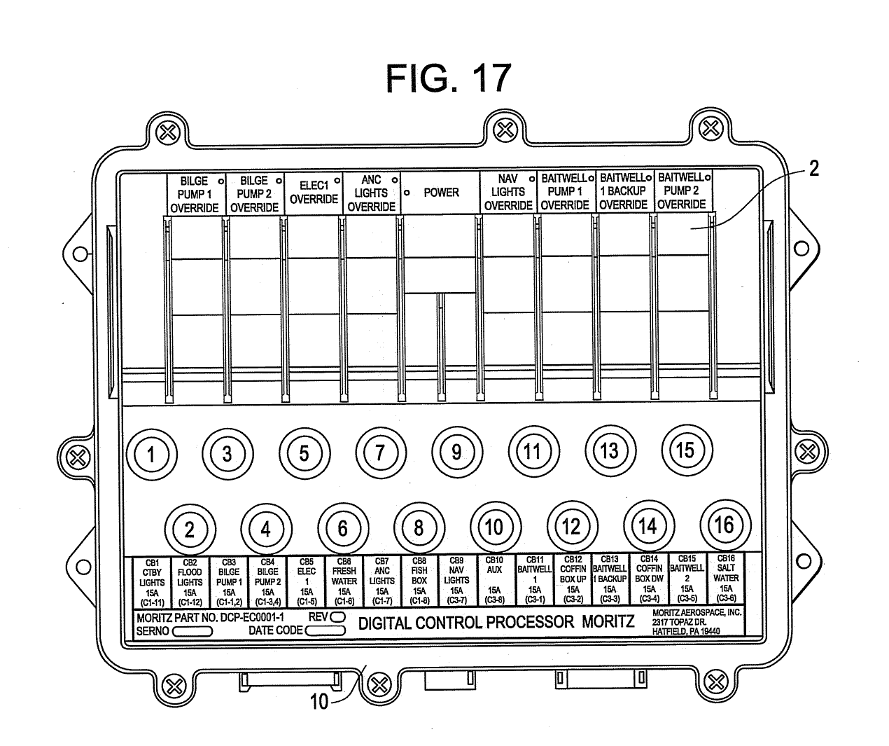

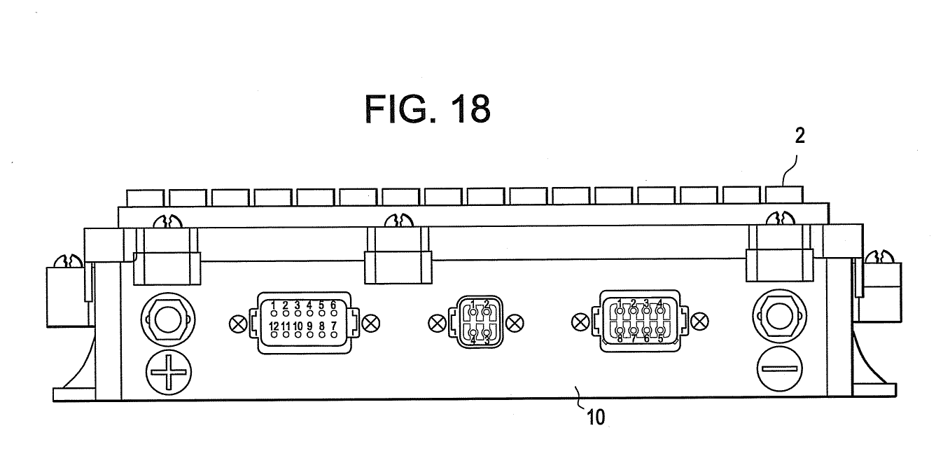

As shown in FIG. 3, DC Electronic Circuit Breakers 14 may be used by the SSPMMS 1. The Electronic Circuit Breakers 14 consistently monitor voltage and amperage, enabling, if desired, the system to compile a history of a particular load's amperage usage to enable pre-failure analysis and maintenance. The ECBs 14 employ pulse-width-modulation (as shown in FIGS. 11 and 12), enabling dimming functionality for the DC lighting loads. Dimming activity may be applied directly to individual circuits, and also applied simultaneously to groups of circuits as specified by the operator through touch screen programming via the touch screen control panels 5.

The standard Electronic Circuit Breaker 14 will switch and protect loads up to 30 amperes with negligible breaker component heating. The desired current protection level for each panel installed ECB will be programmed into the system. Thus, a standard ECB will assume the desired current protection rating when inserted into its particular location in any DC panel. The Electronic Circuit Breakers are extremely reliable, and allow the DC panels to be located in remote areas subject to non air-conditioned temperature variations.

DC current demands higher than 30 amperes may be met with either higher rated ECBs, or the use of hydraulic-magnetic circuit breakers (not shown).

An as option, each Electronic Circuit Breaker 14 may have two LEDs mounted on its top surface. When accessing the DC Circuit Breaker Panel 10, these LEDs will provide visual indication of the health and status of each circuit breaker 14:

| | |
|---|---|
| Breaker switched “OFF” | both LEDs “OFF” |
| Breaker switched “ON” | steady Green LED |
| Breaker “ON” with NO LOAD | flashing Green LED |
| Breaker Tripped | steady Red LED |
| Breaker Failure (replace) | one Red and one Green LED |

The system is designed to guard against the possibility of an electronic circuit breaker 14 becoming locked in the “ON” position. This occurrence is extremely unlikely, but possible. In this event, upon the initiation of an entered command for the circuit breaker to open the circuit, the system will recognize that the ECB is not performing as directed and electrically force open the circuit within the breaker. This will render the circuit breaker inoperable and the simultaneous red and green LEDs on the breaker will indicate that the breaker must be replaced. Also, as shown in FIG. 1C, the switch 3 allows a user to manually bypass any solid state short by switching the switch lever 3 to an “OFF” position.

Discrete Entry Switches

Each DC Circuit Breaker Panel provides for discrete input circuits. These discrete inputs enable the use of separate discrete switches 2 to directly activate any desired Circuit Breakers, or connected components within the SSPMMS 1. This enables the assignment of desired control functions to individual switches 2 in addition to these functions also being able to be controlled via Touch Screen entry on the control panels 5. Thus lighting, horn, trim tab activation, windshield wiper activation, and other similar functions, including variable settings, may be controlled directly by panel or wall mounted rocker/toggle switches, while the Touch Screen control panels 5 will also continue to provide control of these functions and variable settings such as timing, dimming, etc.

Sensor Interface Units

As shown in FIG. 1E, Sensor interface Units 12 are an available option in the solid state remote power management and monitoring system (SSPMMS) 1. Analog alarm and status monitoring devices are connected to the bus through Sensor Interface Units (SIU) 12. Standard SIUs may provide up to 32 analog inputs or digital inputs and may be located throughout the vessel to collect error signal or analog parameters from critical systems such as high water alarms, heat and fire alarms, fuel systems, water systems, etc. A dedicated SIU, the Battery Monitor Unit (BMU) 13, will collect and transmit essential battery bank monitoring information, including voltage, amperage, and battery temperature. Each Sensor Interface Unit 12 if necessary, will process analog signals, convert them to digital, and transmit the information on the bus to all control panels. All interface units are designed and manufactured to meet or exceed the marine ABYC watertight enclosure environmental requirements for salt, fog, and spray.

Data Interface Unit

The Data Interface Unit (DIU) (not shown) in the SSPMMS 1 converts NMEA2000 message packets to RS 232C protocol for Windows or other operating systems based communication with the system, enabling the installer to employ a computer with configuration software to:
Assign current trip levels to the DC Electronic Circuit Breakers (Note: this capability is also available through Touch Screen Panel entry with a security access code)
Program the DC circuits for maintained, momentary, dimmer, and timer operations
Program load assignments for all DC circuit breakers
Analyze the system functionality and troubleshoot
   Systems Monitor Display

The SSPMMS 1 may provide monitoring of onboard systems either by way of a display page on any touch-screen monitor 5, or via a dedicated Systems Monitor Display (SMD). The dedicated SMD provides direct visual and audible monitoring for desired notifications and alarms, such as door or hatch opening, bilge pump activation, high bilge water, overheat, and fire. When activated, alarm notifications will appear concurrently on all System Monitor Displays and on all system Touch Screen Panels. The dedicated Systems Monitor Display will only provide alerts to the specific items that are embedded within the particular monitor, and will not provide control capability within the system. A puslibutton will enable silencing of the audible alarm and display dimming features.

NMEA 2000 Bus Power Module

A NMEA 2000 network cable provides both the NMEA 2000 data bus and the DC power feed to the incorporated electronics of each of the buses connected to the PMMS 1 components, such as the Touch Screen Control control panels 5, DC circuit breaker Panels 10, the AC main distribution Panel 8, the AC circuit breaker sub-Panels 9, and the Sensor Interface Units 12, etc. The power supply providing DC voltage to the bus may be itself powered from both the vessels AC and DC power sources to provide redundancy in the case of either power source being compromised.

Touch Screen Control General Operation

It is recommended that each vessel have a minimum of two Touch Screen Controls (TSCs) control panels 5 to provide system redundancy.

All Touch Screen Controls will provide complete monitoring and, where applicable, control of the various components installed on the system. Thus, the displays may be considered to contain a “controller” per se or the controller may be located externally to the display. An interface may also be included (not shown) to communicate with the buses. Immediate notification for alarm functions and other monitored functions, such as bilge pump operation, high water alarms, fire/heat alarms, battery overheat, etc., will be provided while accessing any screen information. A bilge pump monitor bar and an alert scrolling message bar will appear at the bottom of every system screen view. These notifications may be accompanied by audible alarms as desired and programmed into the system. Circuit breaker tripping indication will receive priority, requiring acknowledgment through the touch panel to clear the tripping indication. Visual indication of a circuit breaker trip may be accompanied by an audible alarm as desired and programmed into the system for circuits such as freezers, refrigerators, battery chargers, etc. All alarm indications and alert notifications, as they become active, will appear simultaneously on screen at all TSCs throughout the vessel.

From any TSC the operator may acknowledge, and investigate within the system, certain occurrences such as a tripped circuit breaker. With the acknowledgment of a tripped breaker warning, the system will bring up on-screen the function of the tripped breaker. The operator then may turn the circuit breaker back on, or investigate further.

By depressing and holding any touch screen activation legend for three to four seconds, the operator may access a detail page for that function. The detail page will specify the panel for the circuit breaker with its location within that panel, and enable modification of its screen label. For DC circuits this page will enable modification of the trip current setting, and will also provide analysis of the current usage for the device on that circuit. Notifications of bilge pump activity, high water alarms, heat and fire alarms, etc., will specify the location of the occurrence and will continue until the situation is corrected. The Touch Screen Control will also provide immediate notification when any DC load is activated and a no-load condition occurs due to a failure of the component or the circuit to the component. The system will enable individual circuit protection for each navigation lamp, with all navigation lamps to be activated with one Touch Screen “button”. In this mode, the system will provide immediate warning of and specific identity of any individual navigation lamp burn out. Touch screen acknowledgement of certain alarm notifications, such as a battery over-heat condition, will activate a detailed information page onscreen relative to that particular function. The detailed page will enable a greater understanding and analysis of the problem.

The operator will have the ability to program the system to restrict operation via any touch screen display 5 for specified circuits. This programming will set a required code to be entered prior to either turning off the specified circuit, or alternatively, activating the circuit. This will enable the operator to protect the system from inadvertent shutdown of important loads, such as freezers, refrigerators, battery chargers, etc., and also protect individuals performing repair or maintenance on a circuit from its inadvertent re-activation.

The operator may also, through any Touch Screen Control (TSC) display 5, access all DC lighting circuits. The TSC will give the operator dimming control for these lighting circuits as desired. Each individual lighting circuit will be defined by the lights connected to any one Electronic Circuit Breaker. The operator may, through TSC entered programming, assign groups of lighting circuits to be dimmed simultaneously, and additionally, assign pre-defined dimming settings for single or selected groups of lights (i.e. “mood lighting”). These groupings and defined lighting settings will be presented with on-screen, operator programmed, descriptive pages.

Additional touch screen enabled programmable features available are:
Load Shedding—The operator may program the system to shed AC or DC loads in desired priority when a specified current level is reached, and reconnect these loads in the order desired as current usage returns below this level.
Brown-out Protection—The operator may program the system to shut down specified loads, such as compressors, refrigerators, and freezers, when voltage drops below a specified level, and re-connect these loads when the voltage level returns to the specified level.
Battery Over-heat Protection—The operator may program the system to shut down the appropriate battery charger if a battery over-heat condition occurs.
Legend Entry—The operator may assign or alter the designated functions of the circuit breakers.
Setting of alert notifications with desired messages for DC current usage levels higher or lower than normal, including open circuit alerts.
DC Trip Current Setting—The operator has limited access to modify DC trip current settings. This capability will enable the replacement of equipment requiring a different current protection level. A not-to-exceed current limit for each circuit will have been programmed by the yacht builder. Trip current alteration must be exercised with caution, and the operator thereby assumes responsibility for assignment of proper current trip level.
Assignment of Legends—the operator may modify existing legends or add legends for spare DC circuits

In summary, the PMMS 1 enables control, monitoring, and programming through all system touch screens of all DC electrical distribution and protection panels throughout the vessel, and all the alarm and monitoring functions that are interfaced to the system via various Sensor Interface Units (SIUs) and Battery Monitor Units (BMUs). In addition, the Touch Screen Controls will interface with additional NMEA 2000 bus connected components, including GPS units, depth-sounders, and electronic compasses.

SMD Systems Monitor Display

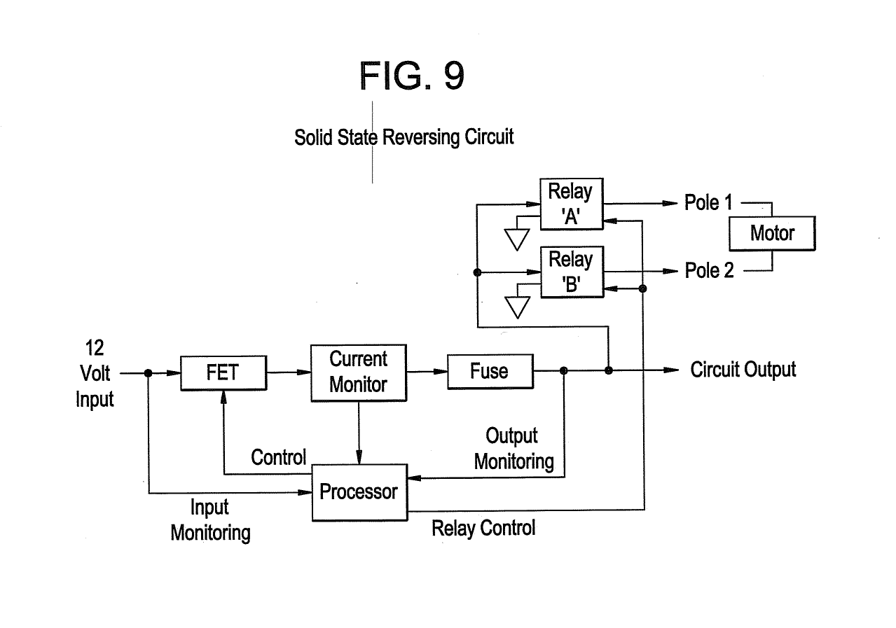

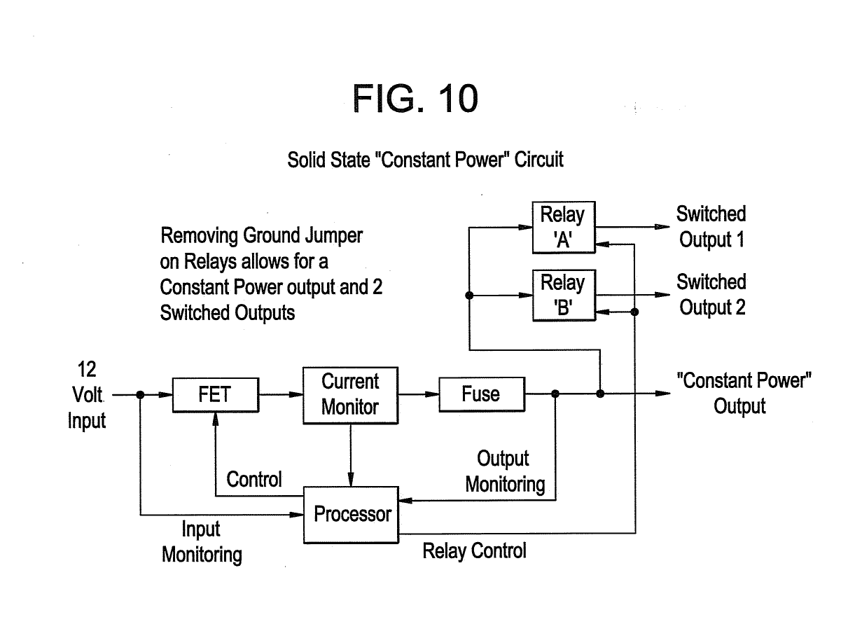

As shown in FIG. 9, the Systems Monitor Display (SMD) on the PMMS 1 is a dedicated fixed legend display that receives its data from the Sensor Interface Units via the CANbus. A green illuminated legend indicates normal operation for the displayed function. A legend that is not illuminated indicates the particular function is “off” or not active. The failure of a function to operate properly, or an alarm status indication, will result in a red legend for that function. Also, when an audible alarm has been assigned to a monitored function with a red indication, the alarm will sound and may be muted by pressing an alarm silence button. The illumination of the legend in red will continue until the problem is corrected. The display may be dimmed by activation of a push button switch.

Fail-Safe Features

Dependable DC power is critical to the safe operation of a marine vessel or in the transportation industry in general. Thus, we have endeavored to develop a system that not only provides incredible benefits, but, most importantly, embodies the utmost in dependability. The PMMS 1 incorporates maximum redundancy and protection against single point failure, a constant goal in aerospace manufacturing.

Dual Bus System and Dual Processor Components

The system is installed with two separate NMEA2000 bus lines, a primary and a secondary, and operates with two processors in the online devices driving both buses. In the event of the failure or severing of the primary bus line, the system automatically switches to the secondary bus and provides notification of the primary bus failure; likewise, should one of the primary bus processors fail in an MCS online device, the system will automatically switch to the secondary bus and provide notification of the failure. At all times the system will also provide immediate notification of secondary bus failure since, while the system operates normally on the primary bus, the secondary bus is kept in active reserve and constantly monitored.

Stand-Alone DC Systems

In the extremely unlikely case of a complete shutdown of power and/or data transmission on the bus, there is no effect on the continuity of the DC systems. The DC system would also continue to operate normally, as active independent power supplies within each DC panel will maintain the dual processors within each panel. These two processors assign the appropriate trip current ratings to the electronic circuit breakers. The internal dual processors and power supplies within each DC panel provide redundancy in case of single point failure. Thus both the NMEA 2000 bus lines could be totally severed and the DC circuit protection systems would continue to function.

Manually Configurable DC System

Should both power supplies, or both processors, fail within any DC panel, the operator may use the mechanical switch 2 at the desired ECB locations to render the circuits active.

Fail-Safe Electronic DC Circuit Protection

The system protects against the unlikely event of an Electronic Circuit Breaker failing in the “ON” position. Should the operator elect to turn “OFF” an ECB and the ECB fails to open the circuit, the system will take the ECB offline. This action will necessitate replacement of the ECB, which will be indicated by the ECB diagnostic LEDs.

Multiple Environmental Protections

The system is designed with multiple features to protect against EMI, RFI, voltage spikes and lightning strikes. The system is rigorously tested to comply with aerospace industry standards and RTCA test levels as specified in DO-160E.

Certifications/Specifications

The SSPMMS 1 is tested to meet the requirements of the Radio Technical Commission for Aeronautics (RTCA) specification DO-160E in all essential categories. The software is in accordance with DO-178 level D. AC circuit breakers are tested to meet Mil Spec standards and will be UL listed devices, with European Agency approvals including CE, as per customer requirements. Certifications will be obtained from certification bodies such as Lloyds, ABS, etc. The system has passed specific testing in actual vessel installation for complete and unaffected operating functionality in high single-sideband RFI environments.

Enclosure Design

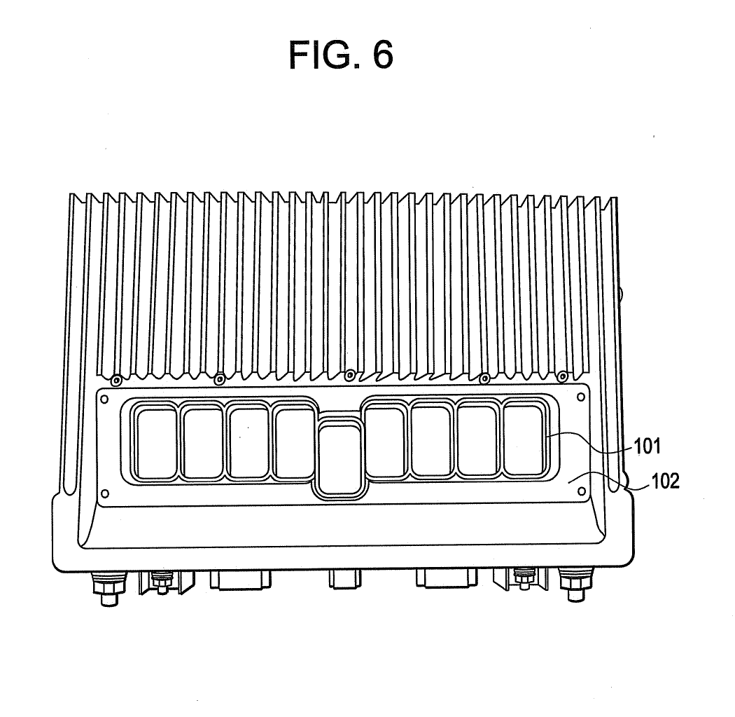

Another feature relates to the unique and useful physical circuit breaker enclosure box 10 itself as best seen in FIGS. 1A and 6. Heat sink 100 is placed on top of enclosure box 10, and flexible plastic cover 100 is held in place by cover 102 so that switches 2 are protected from the environment while still being operable.

Typically in the prior art, a circuit breaker enclosure box is made of inexpensive metal and has a flat interior. Thus, circuit breakers or other devices are mounted by an electrician by drilling holes in the back of the metallic box and by custom mounting each breaker to the metallic box. Also, “punch out” sections are sometimes included to assist in mounting circuit breakers to a metallic box. Furthermore, power connections are typically made in marine applications to be especially strong. For example, a marine screw lug is usually crimped to the end of a connection wire and then the lug is place around a fixing screw so that even if the screw loosens the wire connection does not separate from the screw because it encircles the screw as well. Additionally, individual strain relief mechanisms are typically used by using a screwdriver to punch out a hole to accept the wire and then by tightening a separate set screw to hold the wire against strain. Therefore, mounting and connecting a circuit breaker or connecting a new device or power source is labor intensive. Thus, although a basic metallic box is typically inexpensive, the labor involved in setting up a traditional prior art box requires a large amount of electrician time and expense.

Additionally, when the circuit breaker enclosure box is mounted remotely as it may be in the present overall system, ease of use becomes even more important. For example, if an owner of a recreational vessel wants to add another device to the boat's centralized power bus system it is a serious hindrance to have to hire an electrician or add wiring.

Therefore, as shown in FIGS. 1A and 6, a novel enclosure box 10 design is enclosed which incorporates various important features with the goal of increasing the ease of use to anyone who has to install a device or make a connection to the enclosure box 10 and to decrease the complexity and cost as well to the original manufacture of the yacht.

The enclosure box 10 has been designed from the outset to have a molded plastic base which includes molded plastic stands to accept and mount various parts such as remotely actuated circuit breakers 14, circuit boards, and line bus bars easily in a modular fashion. This eliminates the normal prior art mounting difficulties wherein screw holes had to be drilled into the flat bottom of a metallic box.

Also, the ease of connection is greatly improved as a wire connector can now easily be inserted into connector hole 47 so that strain relief has been eliminated as well.

A clear plastic cover may also be added. Overall, many variations are possible.

Additionally, at least an embodiment of the invention may include a number of remote switching system features, including but not limited to:
15A max per channel continuous load current (20A max per channel momentary load current)
75A total current capacity
Resettable thermal circuit protection
Override mechanical switches for critical functions (3 channels)
Load switching relays
Operating temperature: −40° C. to +70° C.
Controls up to 8 independent channels

Additionally, at least an embodiment of the invention may include a number of electromechanical control system features, including but not limited to:
Robust “CAN BUS” communication
15A max per channel continuous load current (20A max per channel momentary load current)
100A total current capacity
Resettable thermal circuit protection
Override mechanical switches for 8 channels
Flexible configuration
Motor reversing control circuits
EMI/RFI and lightning strike protected
12 or 24V operation
Operating temperature: −40° C. to 70° C.

Additionally, at least an embodiment of the invention may include a number of solid state control system features, including but not limited to:
Robust “CAN BUS” communication
30A max continuous load on four channels (20A max capacity on remaining channels; 20A momentary; 15A continuous)
125A total current capacity (16 channel)
Programmable circuit protection for current level, in-rush and time delay
Auxiliary functions via multiple discrete inputs including dimming timer
Motor reversing control circuits
Flexible configuration
EMI/RFI and lightning strike protected
12 or 24V operation
Operating temperature: −40° C. to +70° C.
Optional ignition protection to UL1500 for marine products
Remote circuit reset

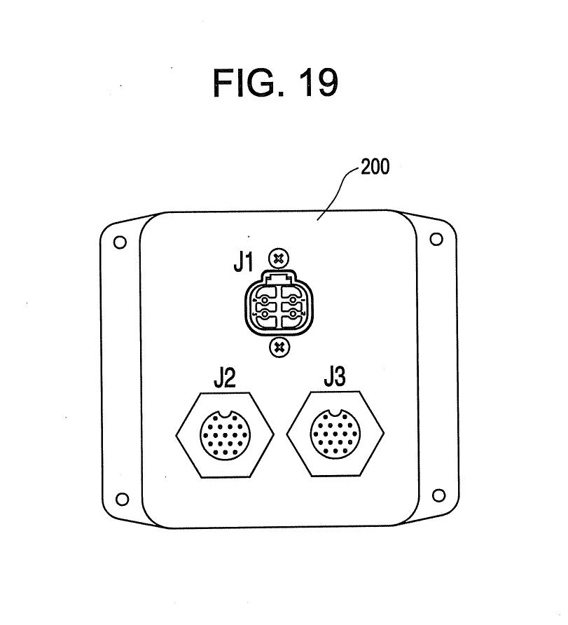

At least an embodiment of the invention may also include switch interface modules 200, as seen in FIG. 19. The switch interface modules 200 allow flexibility to interface with conventional switches. The switch interface module 200 converts discrete inputs received from multiple switches to a serial CAN or NMEA communication link, allowing tremendous savings by eliminating heavy gauge wires and simplifying harness complexity. Rugged compact design of the switch interface module 200 allows total flexibility in switch panel designs. Features of the switch interface module 200 may include but are not limited to:
Interfaces 8 discrete switches to CAN or NMEA communication bus
Provisions for LED and incandescent backlighting and switch indication
NMEA2000 (level B) compliant available
Compact design
Compatible with 12 & 24 VDC systems
Two 18-pin Conxall connectors for switch, dimming, and external power
Device-Net connector for CAN communications
Operating temperature: −40° to +70° C.

At least an embodiment of the invention may also include a base software program that has been developed to provide the installer and end users with the maximum benefit of digital switching technology.

One possible feature of at least an embodiment of the base software program is load protection and circuit shutdown. This feature shuts down low priority circuits during low voltage situations, minimizing the chance of the voltage level dropping to a non-operational low level.

The software constantly monitors the battery voltage and electrical components that are being operated by the Digital Control Processor (DCP). The normal operating range for the 12V DCP to function properly is between 9 volts and 16 volts. The normal operating range for the 24V DCP to function properly is between 18 and 32 volts.

At least an embodiment of the invention can automatically turn OFF circuits at a specific voltage level. Each circuit can be assigned one of three levels of battery protection. By assigning a priority level to each circuit, the system knows which electrical circuit to turn OFF, and in which order, when the battery voltage drops below the programmed Low Voltage Level. Priority Level One Circuits will always remain ON. The operator can override the Circuit Shutdown by pressing the corresponding button on the DCM.

Another possible feature of at least an embodiment of the invention is dedicated bilge pump circuits. Many boats utilizing bilge pumps have an automatic float switch to turn the bilge pump ON in the event of a high water situation. A system according to at least an embodiment of the present invention has provisions to connect the auto float switch to the same circuit protector as the manual bilge pump, eliminating the need for additional circuit protection, or even worse, leaving the auto bilge circuit unprotected. The float switch connection is independent of the electronics and power will be maintained to this connection even if the master power switch on the system is turned OFF. Additionally, the switched line doubles as a sensor that can be configured to detect if the float switch has turned the bilge pump ON and will indicate this on the keypad.

The system may also include the following features:
Ignition Sensing
   The system can be tied to the ignition switch so some features only work when the key is in the ON or accessory position. Other circuits (i.e. bilge) would work regardless of ignition switch position.
Backlighting
   DCM backlighting is controlled by either a particular switch button press or when the ignition switch is in the “ON” position.
Low Battery Sensing
   The system can be configured to sense battery voltage and turn OFF non-critical loads as the battery starts to drain. The levels at which circuits are turned OFF are factory configurable to customer's requirements.
Automatic Shutdown
   The system can be configured to turn OFF all functions after a prescribed period of inactivity.
Configurable Always ON Circuits
   Circuits (relays) can be configured to be ON all of the time. This allows the control system to be used as a distribution panel (i.e. for stereo memory) as well as a switching system.
Bilge Pump Auto Detect Circuit
   The system detects when a bilge pump has been turned ON by a float switch, and will indicate this on the DCM (as required by the American Boat & Yacht Council).
Cloned Switches
   Individual circuits can be controlled with redundant switch buttons on multiple DCMs.
Dimming
   The system can be configured to dim the function indicator LEDs on the DCMs to a preset value by turning on a particular circuit, typically navigation or anchor lights.
Lock-out Circuits
   Lock-out Circuits can be configured to not work if another specific circuit is ON. This is an ideal configuration for motor reversing circuits.
Tripped Circuit Breaker Sensing
   The system will detect when a circuit breaker has tripped and will indicate the trip by flashing the function indicator LED on the DCM.
Motor Reversing
   Individual circuits can be configured to provide motor reversing capability. (Ex. trim tabs, hatch up/down)

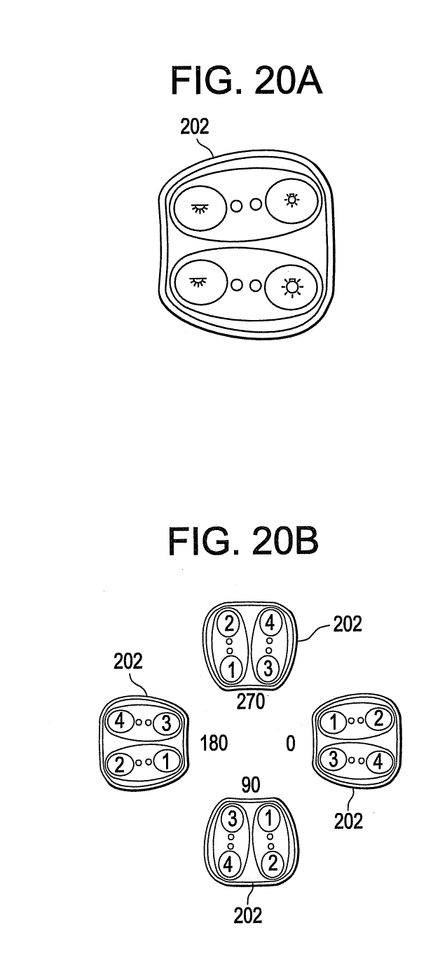

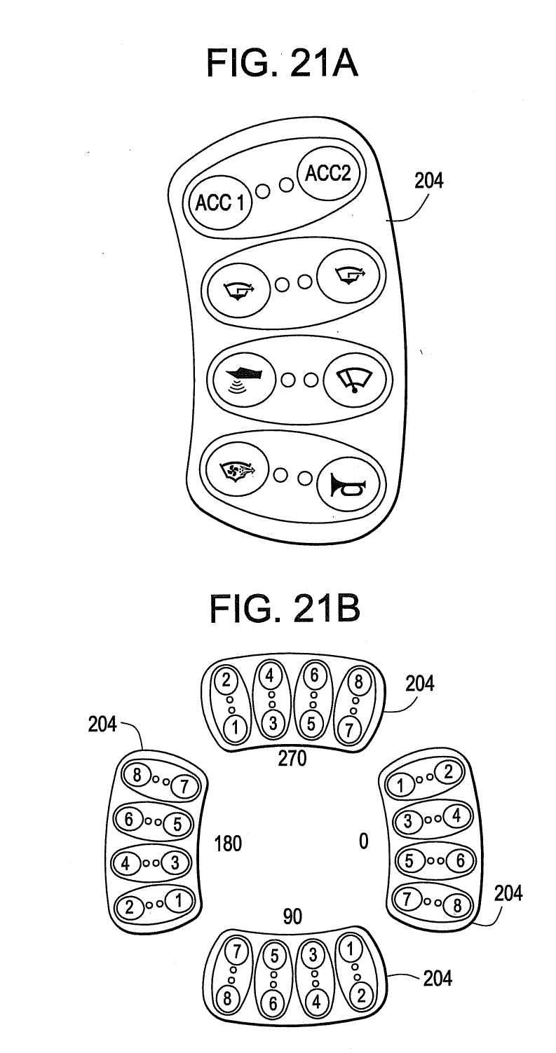

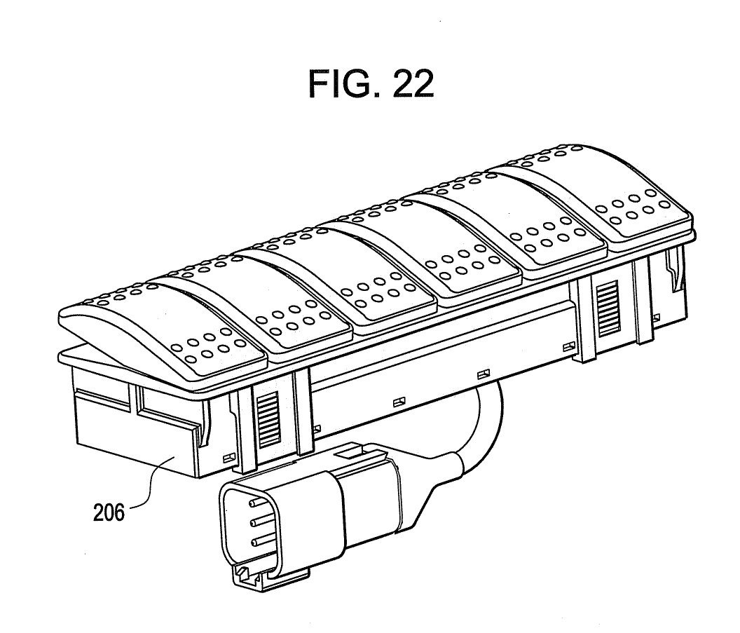

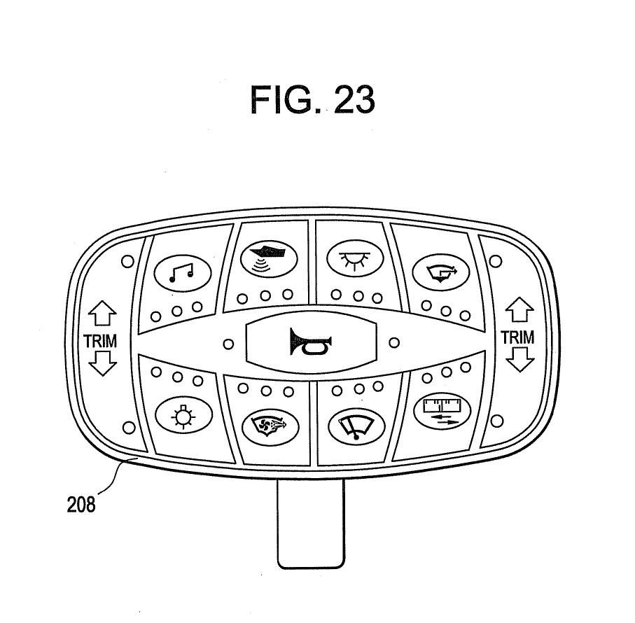

In at least an embodiment of the invention, the display and controller may include a digital control module (DCM). DCMs may include LEDs, which can illuminate when an individual button is activated. FIGS. 20(a) through 23 illustrate some possible embodiments of DCMs. For example, FIG. 20(a) shows a 4-button DCM 202, FIG. 21(a) shows an 8-button DCM 204, FIG. 22 shows a 6-button DCM 206, and FIG. 23 shows a 13-button DCM 208. The DCMs are not limited to these configurations, as many different button configurations are possible. Additionally, multiple DCMs can be combined into a single control panel, as seen in FIGS. 20(b) and 21(b).

It is also envisioned that this system and/or enclosure box maybe used on land as well as part of a building or a residential home, so this system and enclosure box is not limited to marine applications only.

One of ordinary skill in the art can appreciate that a computer or other client or server device can be deployed as part of a computer network, or in a distributed computing environment. In this regard, the methods and apparatus described above and/or claimed herein pertain to any computer system having any number of memory or storage units, and any number of applications and processes occurring across any number of storage units or volumes, which may be used in connection with the methods and apparatus described above and/or claimed herein. Thus, the same may apply to an environment with server computers and client computers deployed in a network environment or distributed computing environment, having remote or local storage. The methods and apparatus described above and/or claimed herein may also be applied to standalone computing devices, having programming language functionality, interpretation and execution capabilities for generating, receiving and transmitting information in connection with remote or local services.

The methods and apparatus described above and/or claimed herein is operational with numerous other general purpose or special purpose computing system environments or configurations. Examples of well known computing systems, environments, and/or configurations that may be suitable for use with the methods and apparatus described above and/or claimed herein include, but are not limited to, personal computers, server computers, hand-held or laptop devices, multiprocessor systems, microprocessor-based systems, network PCs, minicomputers, mainframe computers, distributed computing environments that include any of the above systems or devices.

The methods described above and/or claimed herein may be described in the general context of computer-executable instructions, such as program modules, being executed by a computer. Program modules typically include routines, programs, objects, components, data structures, etc. that perform particular tasks or implement particular abstract data types. Thus, the methods and apparatus described above and/or claimed herein may also be practiced in distributed computing environments such as between different units where tasks are performed by remote processing devices that are linked through a communications network or other data transmission medium. In a typical distributed computing environment, program modules and routines or data may be located in both local and remote computer storage media including memory storage devices. Distributed computing facilitates sharing of computer resources and services by direct exchange between computing devices and systems. These resources and services may include the exchange of information, cache storage, and disk storage for files. Distributed computing takes advantage of network connectivity, allowing clients to leverage their collective power to benefit the entire enterprise. In this regard, a variety of devices may have applications, objects or resources that may utilize the methods and apparatus described above and/or claimed herein.

Computer programs implementing the method described above will commonly be distributed to users on a distribution medium such as a CD-ROM. The program could be copied to a hard disk or a similar intermediate storage medium. When the programs are to be run, they will be loaded either from their distribution medium or their intermediate storage medium into the execution memory of the computer, thus configuring a computer to act in accordance with the methods and apparatus described above.

The term “computer-readable medium” encompasses all distribution and storage media, memory of a computer, and any other medium or device capable of storing for reading by a computer a computer program implementing the method described above.

Thus, the various techniques described herein may be implemented in connection with hardware or software or, where appropriate, with a combination of both. Thus, the methods and apparatus described above and/or claimed herein, or certain aspects or portions thereof, may take the form of program code or instructions embodied in tangible media, such as floppy diskettes, CD-ROMs, hard drives, or any other machine-readable storage medium, wherein, when the program code is loaded into and executed by a machine, such as a computer, the machine becomes an apparatus for practicing the methods and apparatus of described above and/or claimed herein. In the case of program code execution on programmable computers, the computing device will generally include a processor, a storage medium readable by the processor, which may include volatile and non-volatile memory and/or storage elements, at least one input device, and at least one output device. One or more programs that may utilize the techniques of the methods and apparatus described above and/or claimed herein, e.g., through the use of a data processing, may be implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of described above and/or claimed herein may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or a receiving machine having the signal processing capabilities as described in exemplary embodiments above becomes an apparatus for practicing the method described above and/or claimed herein. When implemented on a general-purpose processor, the program code combines with the processor to provide a unique apparatus that operates to invoke the functionality of the methods and apparatus of described above and/or claimed herein. Further, any storage techniques used in connection with the methods and apparatus described above and/or claimed herein may invariably be a combination of hardware and software.

The operations and methods described herein may be capable of or configured to be or otherwise adapted to be performed in or by the disclosed or described structures.

While the methods and apparatus described above and/or claimed herein have been described in connection with the preferred embodiments and the figures, it is to be understood that other similar embodiments may be used or modifications and additions may be made to the described embodiment for performing the same function of the methods and apparatus described above and/or claimed herein without deviating there from. Furthermore, it should be emphasized that a variety of computer platforms, including handheld device operating systems and other application specific operating systems are contemplated, especially given the number of wireless networked devices in use.

While the description above refers to particular embodiments, it will be understood that many modifications may be made without departing from the spirit thereof. The accompanying claims are intended to cover such modifications as would fall within the true scope and spirit of the present invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments and equivalents falling within the scope of the claims.

What is claimed is:

1. A power management and monitoring system for controlling at least one electrical device powered by at least one power supply, wherein the at least one electrical device and power supply are connected by at least one centralized data bus and at least one centralized power bus, the system comprising:
a circuit breaker enclosure box connected to the at least one centralized data bus and the at least one centralized power bus and structured to monitor and manage power to the at least one electrical device via the centralized data bus and the centralized power bus, the circuit breaker enclosure box comprising:
at least one remotely actuated solid state electronic circuit breaker (ECB) structured to monitor and manage power to the at least one electrical device; and
at least one switch connected to each of the at least one remotely actuated electronic circuit breaker, the switch being structured so as to be capable of manually bypassing the ECB; and
at least one display and controller connected to the circuit breaker enclosure box;
wherein the display and controller is structured to remotely monitor the at least one electrical device; and
wherein the display and controller is structured to remotely control the at least one electrical device by remotely actuating the at least one ECB.

2. The system of claim 1, wherein the display and controller is a touch-screen display and controller.

3. The system of claim 1, wherein the display and controller is a programmable input terminal structured to program the system and to update software running on the system.

4. The system of claim 1, wherein the at least one switch comprises a three position switch wherein
when the switch is positioned in a first position, the solid state ECB connected to the switch controls power management of the at least one electrical device;
when the switch is positioned in a second position, the switch manually overrides the ECB connected to the switch and turns off power to the at least one electrical device; and
when the switch is positioned in a third position, the switch manually overrides the ECB connected to the switch and causes power to be supplied to the at least one electrical device.

5. The system of claim 1, further comprising at least one data acquisition unit connected to the centralized data bus or the centralized power bus, wherein the at least one data acquisition unit is structured to collect data from the at least one electrical device or the power supply and transmit the data to the display and controller.

6. The system of claim 5, wherein the at least one data acquisition unit collects and transmits data comprising alarm functions, battery function, engine function, generator data, or lighting.

7. A power management and monitoring system for at least one electrical device on a marine vessel, the system comprising:
a power supply;
at least one centralized power bus connecting the at least one electrical device to the power supply;
at least one centralized data bus connected to the power supply and the at least one electrical device;
a circuit breaker enclosure box connected to the at least one centralized data bus and the at least one centralized power bus and structured to monitor and manage power to the at least one electrical device via the centralized data bus and the centralized power bus, the circuit breaker enclosure box comprising:
at least one remotely actuated solid state electronic circuit breaker (ECB) structured to monitor and manage power to the at least one electrical device; and
at least one switch connected to each of the at least one remotely actuated electronic circuit breaker, the switch being structured so as to be capable of manually bypassing the ECB; and
at least one electronic display and controller connected to the circuit breaker enclosure box;
wherein the display and controller is structured to remotely monitor the at least one electrical device; and
wherein the display and controller is structured to remotely control the at least one electrical device by remotely actuating the at least one ECB.

8. The system of claim 7, wherein the at least one data bus comprises a primary data bus and a secondary data bus, and wherein the system is structured to automatically switch to the secondary data bus if the primary data bus fails.

9. The system of claim 7, wherein the display and controller is a touch-screen display and controller.

10. The system of claim 7, wherein the display and controller is a programmable input terminal structured to program the system and to update software running on the system.

11. The system of claim 7, wherein the at least one switch comprises a three position switch wherein
when the switch is positioned in a first position, the solid state ECB connected to the switch controls power management of the at least one electrical device;
when the switch is positioned in a second position, the switch manually overrides the ECB connected to the switch and turns off power to the at least one electrical device; and
when the switch is positioned in a third position, the switch manually overrides the ECB connected to the switch and causes power to be supplied to the at least one electrical device.

12. The system of claim 7, further comprising at least one data acquisition unit connected to the centralized data bus or the centralized power bus, wherein the at least one data acquisition unit is structured to collect data from the at least one electrical device or the power supply and transmit the data to the display and controller.

13. The system of claim 7, wherein the at least one data acquisition unit collects and transmits data comprising alarm functions, battery function, engine function, generator data, or lighting.

14. The system of claim 7 wherein the system provides remote monitoring and control of electrical loads and means for programmable load shedding.

15. The system of claim 7 wherein the system provides remote monitoring and control of electrical loads and means for programmable low-voltage brown-out protection.

16. The system of claim 7 wherein the system operates according to NMEA 2000 specifications.

17. A method for simplifying the construction and installation of power management and monitoring systems for a marine vessel, transportation vehicle, or building comprising:
providing at least one or more centralized data and power buses for connecting and controlling electrical devices and power supplies on the marine vessel, transportation vehicle, or building;
providing at least one or more display and controller for controlling and monitoring the DC electrical devices and the DC power supplies on the vessel or building via the centralized data and power buses; and
providing at least one or more remotely located and remotely actuated DC circuit breaker enclosure boxes, which are remotely located from the at least one display and controller, and which comprise at least one or more remotely actuated DC circuit breakers located therein wherein the remotely actuated DC circuit breakers are actuated via the centralized data and power buses by the at least one display and controller.

18. A computer program product for power management and monitoring electrical controlled systems for a marine vessel, transportation vehicle, or building, in a computer environment, the computer program product comprising a storage medium readable by a processing circuit and storing instructions for execution by the processing circuit for facilitating a method comprising:
providing data communications via at least one or more centralized data and power buses for connecting and controlling electrical devices and power supplies on the marine vessel, transportation vehicle, or building;
controlling and monitoring the DC electrical devices and the DC power supplies on the vessel or building via at least one or more display and controller via the centralized data and power bus;
controlling the DC power supplies via remotely actuated DC circuit breakers which are actuated via the centralized data bus and power bus by the at least one display and controller; and
providing at least one or more remotely located and remotely actuated DC circuit breaker enclosure boxes, which are remotely located from the at least one display and controller, and which contain the at least one or more remotely actuated DC circuit breakers.

19. The system of claim 7, wherein the at least one ECB is structured to employ pulse-width-modulation to enable dimming of a lighting load.
